(19) United States
(12) Patent Application Publication
(10) Pub. No.: US 2008/0117862 A1
(43) Pub. Date: May 22, 2008

(54) Techniques to use location information to reduce scanning in wireless networks

(76) Inventors: Yerachmiel Yeshayahu, Ra'anana (IL); Penny Efraim Sagi, Moshav Gan Haim (IL); Boaz Pianka, Kohav-Yair (IL)

Correspondence Address: INTEL CORPORATION;c/o INTELLEVATE, LLC, P.O. BOX 52050, MINNEAPOLIS, MN, 55402, US

(21) Appl. No.: 11/601,316

(22) Filed: Nov. 16, 2006

(51) Int. Cl. H04Q 7/00

(52) U.S. Cl. 370/328

(57) ABSTRACT

An embodiment of the present invention provides an apparatus, comprising a wireless client adapted to obtain its location information and based upon the location information, determine its network scanning requirements for a single wireless interface, or a plurality of wireless interfaces connecting to a plurality of networks.

### BACKGROUND

Wireless Local Area Network (WLAN) and Global Positioning System (GPS) receivers are increasingly being integrated in mobile devices, such as PDAs, cellular phones and laptop computers—although the present invention is not limited in this respect. The WLAN receivers provide connectivity to the local area network (LAN), or internet in the vicinity of a Wireless Fidelity (WiFi) Access Point (AP) i.e. a “hotspot”. However, the coverage of a hotspot is limited to few dozen meters, and the user could easily walk into, or out of the coverage area in less than a minute. To offer acceptable hotspot discovery responsiveness, the WLAN receiver needs to scan all possible channels periodically every 60 sec, or less, when not associated to a hotspot. This periodic scanning consumes power from the mobile device battery thereby reducing the standby time.

As power conservation and battery life are paramount for mobility, a strong need exists for techniques to reduce unnecessary scanning in wireless networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 a flowchart of the method of an embodiment of the present invention; and

FIG. 2 is a system of an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth®, ZigBee™, or the like. Embodiments of the invention may be used in various other apparatuses, devices, systems and/or networks.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

An embodiment of the present invention provides using location knowledge to reduce network scanning, such as wireless local area network (WLAN) scanning, and thereby reduce power consumption. Although not limited in this respect as any location determination technique is considered to be within the scope of the present invention, the location knowledge source may be a global position system (GPS) or a location update by any of the wireless interfaces, such as, but not limited to cell change or location area update message in a cellular network.

An embodiment of the present invention may utilize the location information provided by the GPS receiver, or other location methods. After an initial location fix, the GPS may enter a tracking mode, in which the GPS receiver may update the location with periodicity of 60 sec, or less. When no significant change of location is detected from the current Point of Reference, the WLAN receiver may scan with much longer time periods, e.g. 10 min or more. This is due to the assumption that if the mobile device has not moved, it is far less likely that new APs could be detected. Only when the displacement from the current Point of Reference reaches a certain threshold will the WLAN receiver scan all channels, and the new location will become the new Point of Reference.

When not associated, the WLAN receiver needs to scan for new APs every 60 sec, or so (other periods of time can be chosen too). Updating only the GPS location information will consume significantly less energy, and therefore increase battery life. For example, the WLAN needs to scan at least 4 non-overlapping channels of 14 channels in the 2.4 GHz band, and optionally 12 additional channels in the 5 GHz band. For each channel the power consumption is 300 mW, for 100 msec. The average power due to scanning with 60 sec periodicity is therefore ˜8 mW. In contrast, the power consumption for the GPS tracking is in the range of 100-592 μW (depending on the GPS signal level) for the same periodicity.

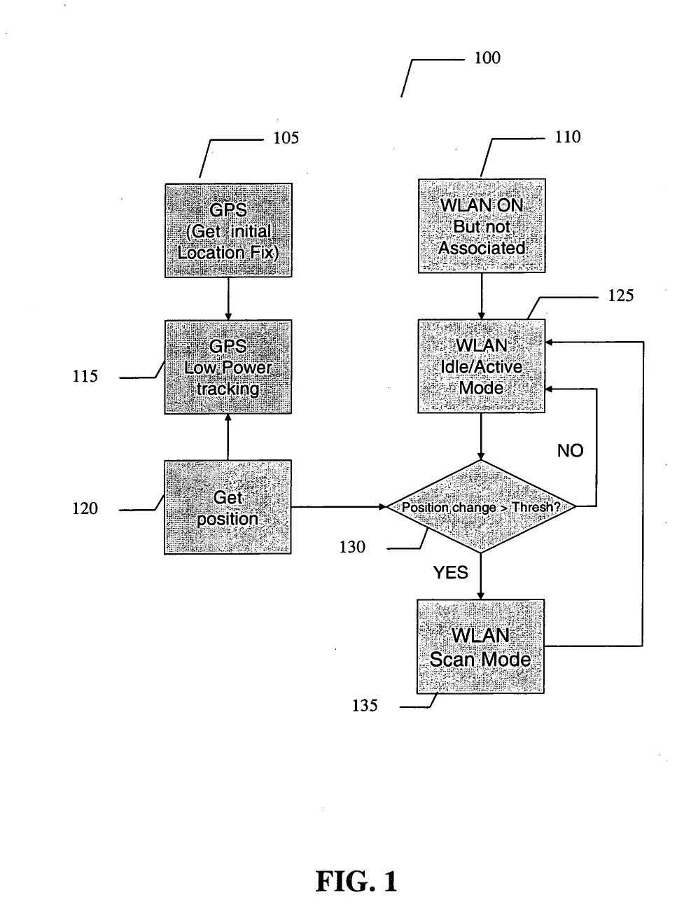

Looking now at FIG. 1 is a flowchart depicting the method of an embodiment of the present invention. At 105 the GPS is on and established an initial location fix, while at 110 the wireless client is on but failed to find or associate to an appropriate Base Station. At 115, the GPS has entered a state in which a 60 second cycle low power tracking is performed and at 125 the wireless client is in the Idle mode in the WLAN. The position is determined at 120 and at 130 if the wireless client has not moved beyond determined parameters, a return to 125 is accomplished. If at 130 the wireless client has moved beyond determined parameters, the wireless client in the WLAN at 125 becomes Active, initiates a scanning mode and subsequently returns to Idle mode.

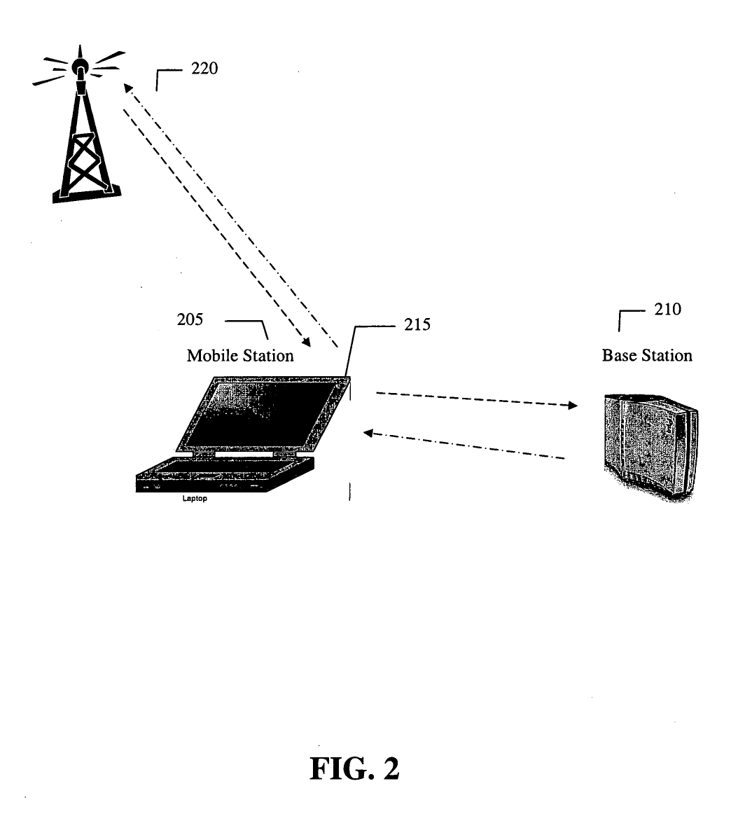

An embodiment of the present invention further provides, as shown in FIG. 2, a system of an embodiment of the present invention. The system comprises, base stations 210, 220 and a wireless client 205 in communication with base station 210 in a wireless local area network (WLAN), and with base station 220 in a wireless wide area network, wherein the wireless client is adapted to obtain its location information and based upon the location information, determine its network scanning requirements for a single wireless interface, or a plurality of wireless interfaces connecting to a plurality of networks. Antenna 215 may be included with base station 210.

In an embodiment of the present invention, if the wireless client determines its location has not changed beyond a predetermined set of parameters applicable to each of the wireless interfaces, the wireless client reduces the periodicity with which it performs scanning, or completely avoids scanning with the network(s). The location information may be determined by using a global positioning system (GPS), or a location update by any of the wireless interfaces, such as, but not limited to cell change or location area update message in a cellular network. However, if the wireless client determines its location has changed beyond a predetermined set of parameters, the wireless client may scan the wireless interfaces to map wireless applications within those networks.

In another embodiment of the present invention, the wireless client may be selected from the group consisting of: a notebook computer, ultra-mobile personal computers (UMPCs), mobile phones or personal digital assistants (PDAs).

Some embodiments of the invention may be implemented, for example, using a machine-readable medium or article which may store an instruction or a set of instructions that, if executed by a machine, for example, by the system of FIG. 2, by station 205 of FIG. 2 in communication with base station 210, by processor (not shown), or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

In an embodiment of the present invention the machine-accessible medium that provides instructions, which when accessed, may cause the machine to perform operations comprising obtaining the location information of a wireless client and based upon the location information, determining the wireless client's scanning requirements for a single wireless interface, or a plurality of wireless interfaces connecting to a plurality of networks. In an embodiment of the present invention the machine-accessible medium may further comprise the instructions causing the machine to perform operations further comprising determining if the wireless client's location has changed beyond a predetermined set of parameters applicable to each of the wireless interfaces, and if not, reducing the periodicity with which the wireless client performs scanning, or completely avoiding scanning with the network(s). The instructions may further comprise determining the location information by using a global positioning system (GPS), or a location update by any of the wireless interfaces and yet may further comprise operating the wireless client in a network that is selected from the group consisting of: a wireless local area network (WLAN), wireless metropolitan area network, wireless wide area network, wireless personal area network or wireless broadcast network.

Some embodiments of the present invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. An apparatus, comprising:
a wireless client adapted to obtain its location information and based upon said location information, determine its network scanning requirements for a single wireless interface, or a plurality of wireless interfaces connecting to a plurality of networks.

2. The apparatus of claim 1, wherein if said wireless client determines its location has not changed beyond a predetermined set of parameters applicable to each of the wireless interfaces, said wireless client reduces the periodicity with which it performs scanning, or completely avoids scanning within said network(s).

3. The apparatus of claim 1, wherein said location information is determined by using a global positioning system (GPS), or a location update by any of the wireless interfaces.

4. The apparatus of claim 1, wherein said network(s) are selected from the group consisting of: a wireless local area network (WLAN), wireless metropolitan area network, wireless wide area network, wireless personal area network or wireless broadcast network.

5. The apparatus of claim 1, wherein said wireless client is selected from the group consisting of: a notebook computer, ultra-mobile personal computers (UMPCs), mobile phones or personal digital assistants (PDAs).

6. The apparatus of claim 4, wherein if said wireless client determines its location has changed beyond a predetermined set of parameters, said wireless client scans said wireless network(s) to map wireless applications within said wireless network(s).

7. A method, comprising:
obtaining the location information of a wireless client and based upon said location information, determining said wireless client's scanning requirements for a single wireless interface, or a plurality of wireless interfaces connecting to a plurality of networks.

8. The method of claim 7, further comprising determining if said wireless client's location has changed beyond a predetermined set of parameters applicable to each of the wireless interfaces, and if not, reducing the periodicity with which said wireless client performs scanning, or completely avoiding scanning with said network(s).

9. The method of claim 7, further comprising determining said location information by using a global positioning system (GPS), or a location update by any of the wireless interfaces.

10. The method of claim 7, wherein said network is selected from the group consisting of: a wireless local area network (WLAN), wireless metropolitan area network, wireless wide area network, wireless personal area network or wireless broadcast network.

11. The method of claim 7, further comprising selecting said wireless client from the group consisting of: a notebook computer, ultra-mobile personal computers (UMPCs), mobile phones or personal digital assistants (PDAs).

12. The method of claim 10, further comprising scanning by said wireless client of said wireless network if said wireless client determines its location has changed beyond a predetermined set of parameters to map wireless applications within said wireless network.

13. A machine-accessible medium that provides instructions, which when accessed, cause a machine to perform operations comprising:
obtaining the location information of a wireless client and based upon said location information, determining said wireless client's scanning requirements for a single wireless interface, or a plurality of wireless interfaces connecting to a plurality of networks.

14. The machine-accessible medium of claim 13, further comprising said instructions causing said machine to perform operations further comprising determining if said wireless client's location has changed beyond a predetermined set of parameters applicable to each of the wireless interfaces, and if not, reducing the periodicity with which said wireless client performs scanning, or completely avoiding scanning with said network(s).

15. The machine-accessible medium of claim 14, further comprising said instructions causing said machine to perform operations further comprising determining said location information by using a global positioning system (GPS), or a location update by any of the wireless interfaces.

16. The machine-accessible medium of claim 13, further comprising said instructions causing said machine to perform operations further comprising operating said wireless client in a network that is selected from the group consisting of: a wireless local area network (WLAN), wireless metropolitan area network, wireless wide area network, wireless personal area network or wireless broadcast network.

17. The machine-accessible medium of claim 13, wherein said medium resides on an wireless client that is selected from the group consisting of: a notebook computer, ultra-mobile personal computers (UMPCs), mobile phones or personal digital assistants (PDAs).

18. The machine-accessible medium of claim 16, further comprising said instructions causing said machine to perform operations further comprising scanning by said wireless client of said wireless network if said wireless client determines its location has changed beyond a predetermined set of parameters to map wireless applications within said wireless network.

19. A system, comprising:
base stations providing access to one or more wireless access networks;
a wireless client in communication with said base stations in the wireless access networks, wherein said wireless client is adapted to obtain its location information and based upon said location information, determine its network scanning requirements for a single wireless interface, or a plurality of wireless interfaces connecting to a plurality of networks.

20. The system of claim 19, wherein if said wireless client determines its location has not changed beyond a predetermined set of parameters applicable to each of the wireless interfaces, said wireless client reduces the periodicity with which it performs scanning, or completely avoids scanning with said network(s).

21. The system of claim 19, wherein said location information is determined by using a global positioning system (GPS), or a location update by any of the wireless interfaces.

22. The system of claim 21, wherein said wireless client is selected from the group consisting of: a notebook computer, ultra-mobile personal computers (UMPCs), mobile phones or personal digital assistants (PDAs).

23. The apparatus of claim 21, wherein if said wireless client determines its location has changed beyond a predetermined set of parameters, said wireless client scans said wireless interfaces to map wireless applications within said wireless access networks.
